(19) United States
(12) Patent Application Publication
(10) Pub. No.: US 2020/0398204 A1
(43) Pub. Date: Dec. 24, 2020

(54) FILTER ASSEMBLY WITH INDEPENDENTLY REMOVABLE FILTERS

(71) Applicant: PAT TECHNOLOGY SYSTEMS INC., Vaudreuil-Dorion (CA)

(72) Inventors: Chau VO, Roxboro (CA); Anthony KAZAZIAN, Brossard (CA); Wayne BAIRD, Saint-Lazare (CA)

(21) Appl. No.: 16/955,368

(22) PCT Filed: Dec. 20, 2018
(86) PCT No.: PCT/CA2018/051631

§ 371 Date: Jun. 18, 2020

Related U.S. Application Data
(60) Provisional application No. 62/608,340, filed on Dec. 20, 2017.

(51) Int. Cl. B01D 46/00

(52) U.S. Cl. CPC B01D 46/0005; B01D 46/2411; B01D 46/0023

(57) ABSTRACT

A filter assembly for a fume extraction system including a plurality of filters spaced apart from one another, a plurality of pipe sections serially interconnecting the filters such that each of the filters extends between first and second corresponding ones of the pipe sections, each of the filters having a first wall and a second wall opposite the first wall, the first and second walls each having a respective opening defined therethrough, the opening of the first wall fluidly connected to the first corresponding pipe section, the opening of the second wall fluidly connected to the second corresponding pipe section. For each of the filters, first and second respective locking mechanisms releasably engage the filter to the corresponding pipe sections such that each of the filters is independently removable from the filter assembly through release of the respective locking mechanisms.

### TECHNICAL FIELD

The application relates generally to fume extraction systems and, more particularly, to filter assemblies for such systems.

### BACKGROUND OF THE ART

In many industries such as electronics fabrication, laser marking, laser cutting, and laser engraving, fume extraction systems are used to capture particulate and gaseous/vaporised materials generated by the industrial processes. Fume extraction systems typically include filter assemblies with different types of filters (e.g. particulate filters of different grades, gas filter). As the filters collect the contaminants, they reach a point where they either lose efficiency or restrict the air. This point is specific and different for each filter given that the filters remove different types and/or sizes of contaminants from the air. Thus, it is expected that the filters have to be replaced at different intervals from each other.

One type of known fume extraction system usually includes a filter assembly with the different filters all housed in a single unit enclosure. Each filter is typically provided as a cartridge constructed with a continuous perimeter wall and opposed open faces with the filter medium spanning the internal space defined by the perimeter wall. Partial dividers in the single unit enclosure create dedicated chambers for each individual filter cartridge while allowing the filters to be in serial fluid communication with each other without air bypass around the exterior of the filter wall and the internal walls of the main enclosure. While the single unit enclosure configuration typically allows the filter cartridges to be removed independently, this type of filter assembly is usually costly and/or complex to produce given that it requires more material, labor and/or significant tooling to create the single unit enclosure e as well as the filter cartridges.

Another type of known fume extraction system includes a filter assembly with different types of filters stacked one on top of another, with adjacent perimeter walls of the adjacent filter cartridges defining the conduit for the air circulation throughout the assembly, and the adjacent filters being sealingly engaged together end-to-end. Such a configuration may be less costly to produce than a single unit enclosure. However, because the filters are stacked one on top of another, the filters are sequentially dependent. If a filter other than the topmost filter needs to be changed, the filter(s) above the filter that needs to be changed must also be removed. Accordingly, filter replacement may be more time consuming and/or impractical in tight work spaces.

Another type of fume extraction system includes a filter assembly where one or more filter(s) is/are housed in a single unit enclosure while one or more other filter(s) is/are stacked one on top of another and/or on top of the single unit enclosure. This “combined” configuration suffers from the same drawbacks set forth above.

### SUMMARY

In one aspect, there is provided a filter assembly for a fume extraction system, the assembly comprising: a plurality of filters spaced apart from one another; a plurality of pipe sections serially interconnecting the filters such that each of the filters extends between first and second corresponding ones of the pipe sections, each of the filters having a first wall and a second wall opposite the first wall, the first and second walls each having a respective opening defined therethrough, the opening of the first wall fluidly connected to the first corresponding one of the pipe sections, the opening of the second wall fluidly connected to the second corresponding one of the pipe sections; and for each of the filters, first and second respective locking mechanisms releasably engaging the filter to the first and second corresponding ones of the pipe sections such that each of the filters is independently removable from the filter assembly through release of the first and second respective locking mechanisms.

In particular embodiments, the filter assembly may include any one or any suitable combination of the following:
the first and second locking mechanisms provide a clamping force along a direction transverse to a direction of flow within the pipe sections;
for each of the filters: a first respective seal assembly defining a sealed engagement between the opening of the first wall and the first corresponding one of the pipe sections, the first respective seal assembly including a first seal member extending from the first wall around the opening defined therethrough, and a second seal member provided on the first corresponding one of the pipe sections and sealingly engaged to the first seal member, the first and second seal members being configured so that engaging surfaces thereof extend non-parallel to the direction of the clamping force; and a second respective seal assembly defining a sealed engagement between the opening of the second wall and the second corresponding one of the pipe sections, the second respective seal assembly including a third seal member extending from the second wall around the opening defined therethrough, and a fourth seal member provided on the second corresponding one of the pipe sections and sealingly engaged to the third seal member, the third and fourth seal members being configured so that engaging surfaces thereof extend non-parallel to the direction of the clamping force;
the first, second, third and fourth seal members are curved and/or define a sequence of generally straight segments (for example with a slight curvature between the straight segments resulting from deformation);
the first respective seal assembly further includes a first additional seal member on a perimeter wall of the filter adjacent the opening of the first wall and in abutment with a support of the pipe sections, and a second additional seal member on the support and sealingly engaged to the first additional seal member, the first and second additional seal members being configured so that engaging surfaces thereof extend non-parallel to the direction of the clamping force; and the second respective seal assembly further includes a third additional seal member on the perimeter wall of the filter adjacent the opening of the third wall, and a fourth additional seal member on the support and sealingly engaged to the third additional seal member, the third and fourth additional seal members being configured so that engaging surfaces thereof extend non-parallel to the direction of the clamping force;
the filters are vertically spaced apart;
the first wall is a top wall and the second wall is a bottom wall, the assembly further comprising a pair of support arms extending from the second corresponding one of the pipe sections, the bottom wall resting on the support arms;
an upstream-most of the filters is located on top of remaining ones of the filters, the assembly further comprising an inlet duct having an inlet defined at a lower end thereof adjacent a lowest of the filters, the inlet duct extending upwardly from the inlet adjacent the filters and having a U-shaped portion adjacent a connection between the inlet duct and the upstream-most of the filters;
a topmost of the filters has an enlarged top wall having a cross-sectional area greater than that defined by a perimeter wall of the topmost filter, the enlarged top wall usable as a workstation;
the filters include at least one particulate filter and at least one gaseous filter;
the filters are horizontally spaced apart;
each of the pipe sections has a cross-sectional area smaller than a cross-sectional area of any one of the filters.

In another aspect, there is provided a filter assembly for a fume extraction system, the assembly comprising: a plurality of filters spaced apart from one another; and a plurality of pipe sections serially interconnecting the filters, each of the filters having two opposed walls interconnected by a perimeter wall defining a closed perimeter, each of the opposed walls having an opening defined therethrough, the opening of a first one of the opposed walls defining an inlet and the opening of a second one of the opposed walls defining an outlet, each opening fluidly connected to a respective one of the pipe sections via a respective seal assembly; wherein each respective seal assembly includes: a locking mechanism engaging the filter to the respective pipe section, the locking mechanism providing a compression force along a direction transverse to a direction of flow within the pipe sections; at least one seal member on the filter around the opening; at least one seal member on the respective pipe section and sealingly engaged to the at least one seal member on the filter, the seal members on the filter and respective pipe section being configured so that engaging surfaces thereof extend non-parallel to the direction of the clamping force.

In particular embodiments, the filter assembly may include any one or any suitable combination of the above-mentioned features.

In a further aspect, there is provided a filter comprising: a perimeter wall defining a closed perimeter surrounding filter medium, and first and second walls interconnected by the perimeter wall to enclose the filter medium, the first wall having an opening therethrough defining an inlet, the second wall having an opening therethrough defining an outlet; and a flow distribution plate provided between the first wall and the filter medium and spaced apart from the first wall, the flow distribution plate aligned with the opening defined through the first wall.

The filter may be used in any of the above-mentioned filter assemblies.

In particular embodiments, the filter may include any one or any suitable combination of the following:
a second flow distribution plate provided between the second wall and the filter medium and spaced apart from the second wall, the flow distribution plate aligned with the opening defined through the second wall;
a surface area of the flow distribution plate is approximately equal to a cross-sectional area of the opening through the first wall;
the closed perimeter is rectangular, the opening through the first wall is non-rectangular, and the flow distribution plate is rectangular;
the opening in the first wall occupies at least 4% of a surface area of the first wall;
the filter medium includes activated carbon.

### DESCRIPTION OF THE DRAWINGS

Reference is now made to the accompanying figures in which:

FIG. 1 is a schematic tridimensional view of a filter assembly in accordance with a particular embodiment;

FIG. 2 is a schematic side cross-sectional view of the filter assembly of FIG. 1;

FIGS. 3a and 3b are schematic tridimensional views of part of a filter assembly such as shown in FIG. 1, in accordance with a particular embodiment;

FIGS. 4a and 4b are schematic tridimensional views of part of a seal assembly of the filter assembly of FIG. 3;

FIGS. 5a and 5b are schematic tridimensional views of a filter of the filter assembly of FIGS. 3a and 3b, respectively, showing another part of a seal assembly;

FIGS. 6a-6d are schematic cross-sectional views of the seal assembly of FIGS. 4-5, in a disengaged configuration (FIGS. 6a, 6c) and in an engaged and locked configuration (FIGS. 6b, 6d);

FIGS. 7a and 7b are schematic exploded view of a filter of the filter assembly of FIGS. 3a and 3b, respectively, in accordance with a particular embodiment;

FIG. 8a is a schematic illustration of a flow through the filter of FIG. 7a, in accordance with a particular embodiment;

FIG. 8b is a schematic illustration of the flow through the filter of FIG. 7a, with flow distribution plates of the filter assembly removed;

FIGS. 9a-9d are schematic tridimensional views of the filter assembly of FIG. 3, illustrating the independently removable filters;

FIG. 10a is a schematic tridimensional view of a filter assembly in accordance with another particular embodiment;

FIG. 10b is a schematic side cross-sectional view of the filter assembly of FIG. 10a;

FIG. 11a is a schematic tridimensional view of a filter assembly in accordance with another particular embodiment;

FIG. 11b is a schematic side cross-sectional view of the filter assembly of FIG. 11a;

FIG. 12 is a schematic tridimensional view of the filter assembly of FIG. 3, illustrating an optional enlarged top wall in accordance with a particular embodiment.

### DETAILED DESCRIPTION

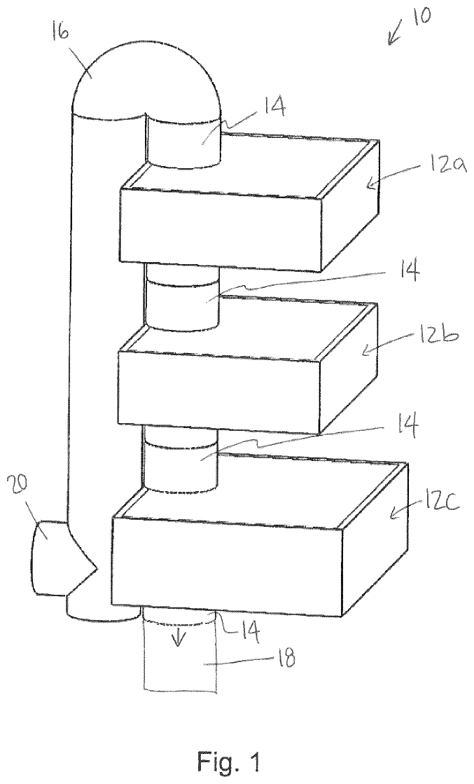

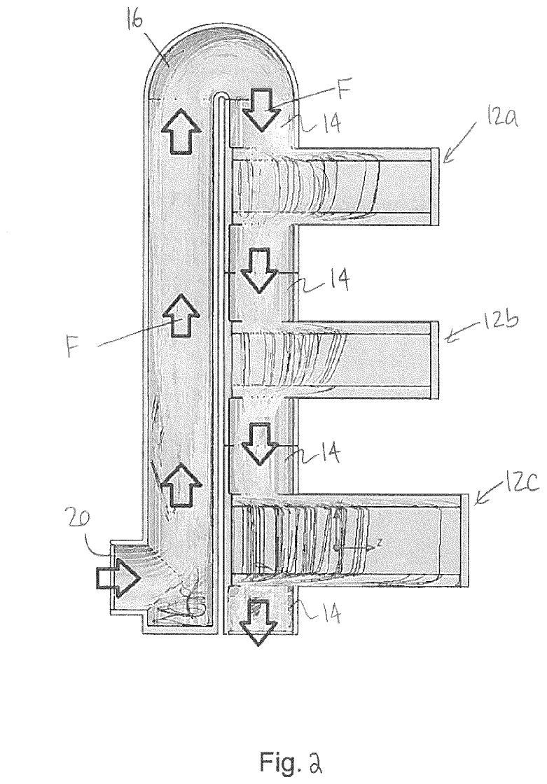

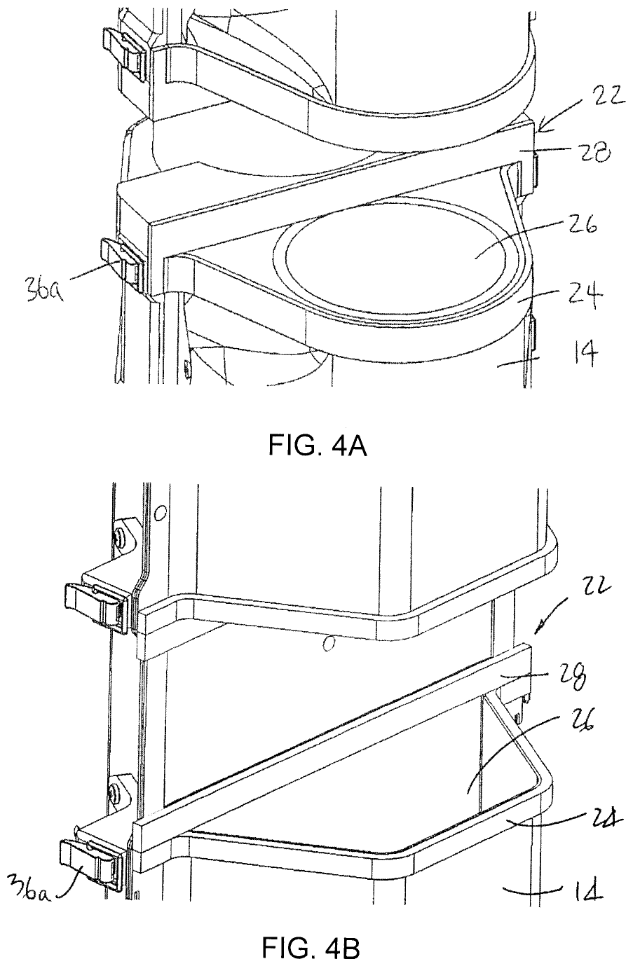

Referring to FIGS. 1-2, a filter assembly 10 for a fume extraction system in accordance with a particular embodiment is shown. The filter assembly generally includes a plurality of spaced apart filters 12a, 12b, 12c serially interconnected by pipe sections 14, so that each filter 12a, 12b, 12c is “sandwiched” between and sealingly engaged to two of the pipe sections 14. Although three filters 12a, 12b, 12c are shown, it is understood that alternately, more or less filters may be provided. In the embodiment shown, the direction of flow F (FIG. 2) through the filters 12a, 12b, 12c is from top to bottom. Each pipe section 14 has a cross-sectional area (defined perpendicularly to the direction of flow F) which is smaller, and in a particular embodiment substantially smaller, than the cross-sectional area of each filter 12a, 12b, 12c. The cross-sectional area of the pipe sections 14 is however sufficiently large so as to have acceptable static pressure losses, e.g. to reach a balance between the required pressure to overcome the flow restriction in the pipe sections 14 and the costs of the vacuum system required to create such a pressure. The cross-sectional area of the pipe sections 14 may have different shapes, such as circular as in FIGS. 1 and 2, polygonal, etc. FIG. 4a shows for example one possible shape, namely a trapezoid pipe section (also known as half-hexagonal). In a particular embodiment, each pipe section 14 has a cross-sectional area which corresponds to one or more of the following: at least 4% of the cross-sectional area of any one of the filters 12a, 12b, 12c connected to it; at most 50% of the cross-sectional area of any one of the filters 12a, 12b, 12c connected to it; at most 98% of the cross-sectional area of any one of the filters 12a, 12b, 12c connected to it. Other values are also possible. In a particular embodiment, the filters 12a, 12b, 12c include at least one particulate filter and at least one gaseous filter. In a particular embodiment, the filters 12a, 12b, 12c include graded particulate filters arranged from lowest to highest efficiency along the direction of flow, and a gaseous filter (e.g. including activated carbon) which is preferably placed at the bottommost position. Other configurations are also possible.

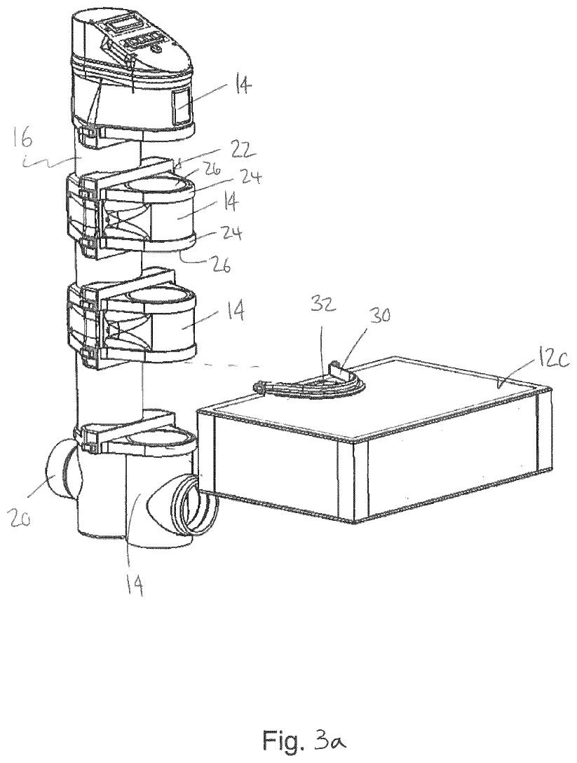

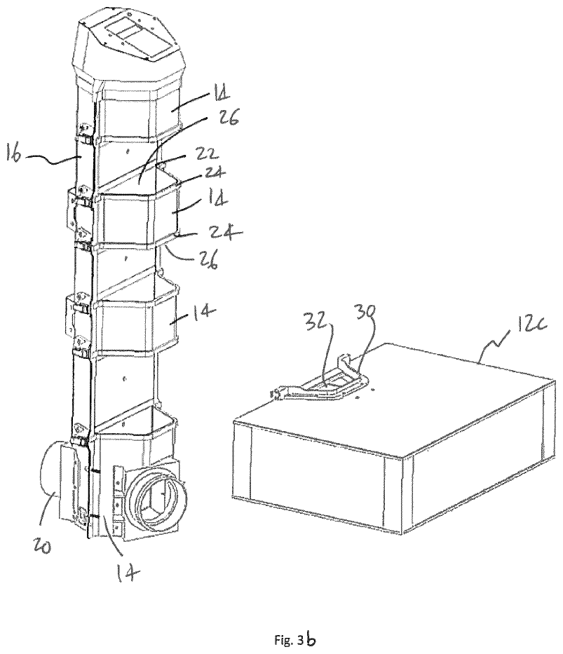

An inlet duct 16 is in fluid communication with the pipe section 14 immediately upstream of the upstream-most filter 12a, and a vacuum source 18 (FIG. 1) is in fluid communication with the pipe section 14 immediately downstream of the downstream-most filter 12c. In the example shown below, the filter assembly 10 is oriented vertically. An inlet 20 of the assembly 10 may be for example close to the ground, and the inlet duct 16 has an inverted U-shape portion adjacent the connection to the upstream-most filter 12a. The inlet duct 16 thus extends upwardly from the inlet 20 and then back down to define the pipe section 14 communicating with a top inlet of the upstream-most filter 12a. In a particular embodiment, the U-shaped configuration of the inlet duct 16 may reduce the tipping moment generated by movements of an inlet hose (not shown) connected to the inlet 20 and accordingly increase the stability of the filter assembly 10. It is understood that the particular configuration shown is exemplary only and that any other suitable configuration may alternately be used, including, but not limited to, the alternate embodiments described further below. FIG. 3b shows another contemplated embodiment, in which the inlet duct 16 and the pipe sections 14 are trapezoidal in shape, separated by a wall 16a that may be a symmetry line. The combined cross-section of the inlet duct 16 and the pipe sections 14 may even be hexagonal in shape. A stiffening plate 16b may also be present, for example in the inlet duct 16. The embodiment of FIG. 3b is well suited for being manufactured largely In sheet metal, as an example, though it could be made of other materials such as plastics. The same applies to the embodiment of FIG. 3a.

Referring particularly to FIG. 2, the flow F through the filter assembly 10 is shown. The flow F circulates upwards from the inlet 20 via the inlet duct 16, and then turns to circulate downwards through the filters 12a, 12b, 12c. It can be seen that each filter 12a, 12b, 12c has an independent casing built around it, and the filters 12a, 12b, 12c are spaced apart from each other and independently sealingly engaged to the two pipe sections 14 connected thereto, so that each filter 12a, 12b, 12c can be individually and independently removed from the assembly 10.

Referring to FIGS. 3a-6d, a seal assembly between the filter 12a, 12b, 12c and the adjacent pipe sections 14 in accordance with a particular embodiment is shown. As can be best seen in FIGS. 4a and 4b, each pipe section 14 is mounted on a support 22 which is connected to the inlet duct 16 or to any other suitable support structure. A seal member (e.g. curved gasket as in FIG. 4a, a straight-segment gasket as in FIG. 4b) 24 is provided on the outer surface of the pipe section 14 adjacent the opening 26 (inlet or outlet) in communication with the adjacent filter 12a, 12b, 12c. A flat seal member (e.g. flat gasket) 28 is provided on the support 22 adjacent the opening 26. Each pipe section 14 located intermediate two of the filters 12a, 12b, 12c thus includes two seal members 24 on its outer surface, one adjacent each end, and two flat seal members 28 provided on the support 22, one adjacent each end of the pipe section 14.

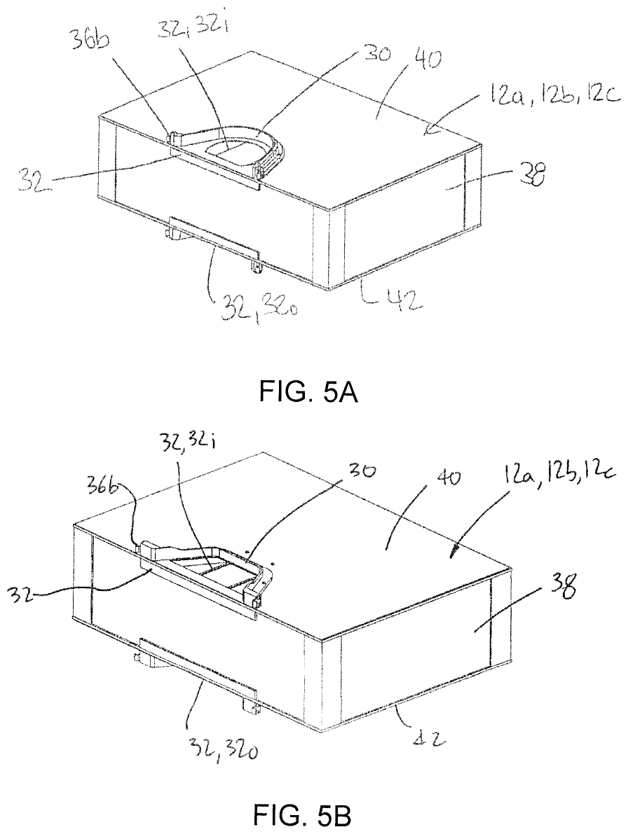

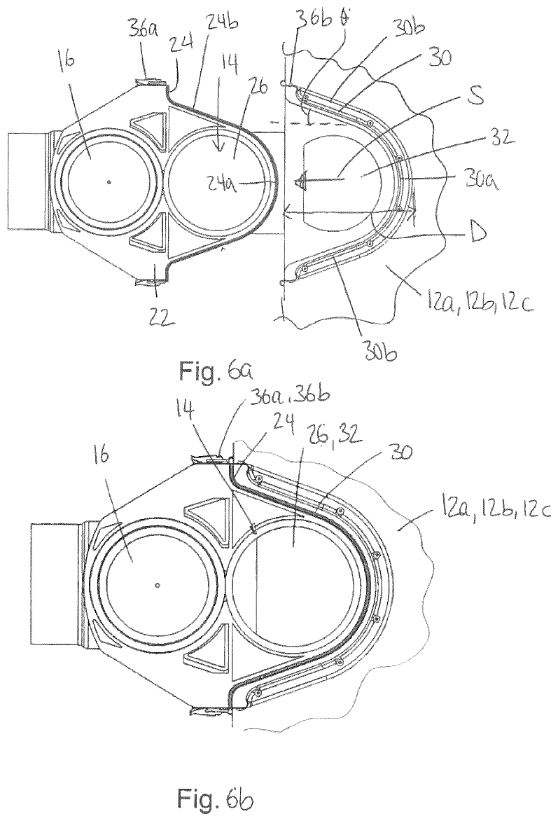

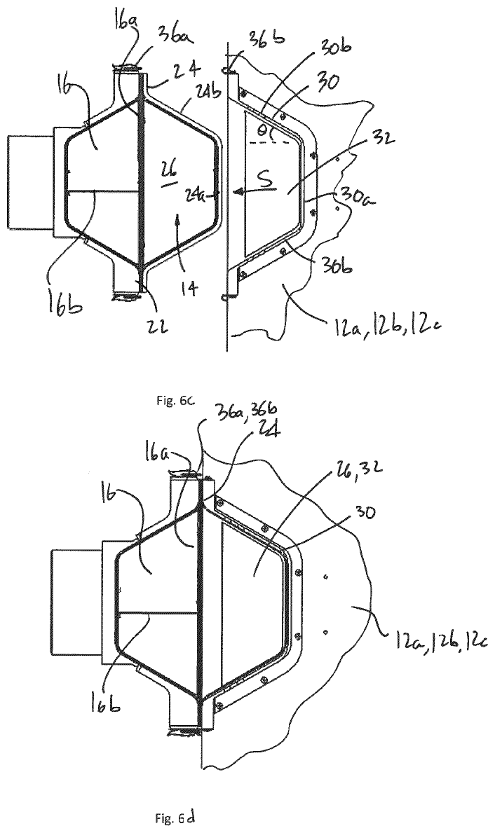

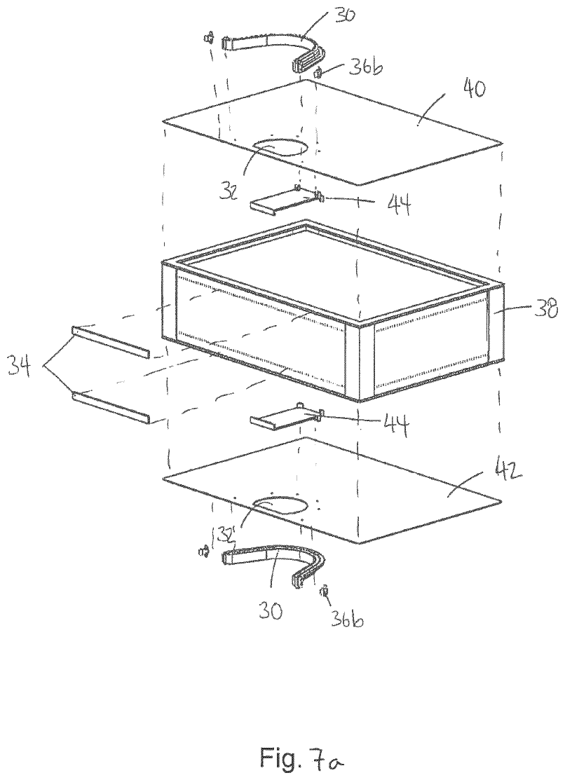

As can be best seen in FIGS. 5a and 5b, the filter 12a, 12b, 12c has a casing formed by perimeter walls 38 which interconnect an inlet (top) wall 40 and an outlet (bottom) wall 42. Each of the top and bottom wall 40, 42 has an opening 32 defined therethrough adjacent one edge; the opening 32i in the inlet wall 40 serves as the exclusive air inlet to the filter 12a, 12b, 12c and the opening 32o in the outlet wall 42 serves as the exclusive outlet from the filter 12a, 12b, 12c, therefore allowing a flow path from one side of the filter, through the filter medium to the other side of the filter via the openings 32. The cross-sectional area of the opening 32 is small, and in a particular embodiment substantially small, when compared to the surface area of the wall 40, 42; the exemplary values provided above for the proportion between the cross-sectional areas of the pipe sections 14 and of the filters 12a, 12b, 12c apply to the proportion between the opening 32 and the surface area of the wall 40, 42. As can be best seen in FIGS. 6b and 6d, when installed the filter 12a, 12b, 12c intersects the adjacent pipe sections 14 so that there is alignment of the filter openings 32 and of the openings 26 of the adjacent pipe sections 14, allowing air to travel from one pipe section 14, through the filter inlet opening 32i, through the filter medium, though the filter outlet opening 320 and finally through to the other pipe section 14, completing the continuous air path.

Referring back to FIGS. 5a and 5b, a seal member (e.g. curved seal surface in FIG. 5a, straight segment seal surface in FIG. 5b) 30 extends from the casing of the filter 12a, 12b, 12c around the opening 32i, 32o in communication with the adjacent pipe section 14. The seal member 30 is sized and shaped so as to be complementary to the corresponding seal member 24 of the pipe section 14, as detailed further below. A flat seal member (e.g. flat seal surface) 34 is provided on the casing of the filter 12a, 12b, 12c, on the perimeter wall to be abutted to the support 22, along the edge adjacent the opening 32. Each filter 12a, 12b, 12c may thus include two seal members 30, one extending around each of its inlet and outlet 32, and two flat seal members 34 on the same perimeter wall of the casing, along the edge adjacent the inlet 32i and the edge adjacent the outlet 32o (top and bottom edges in the embodiment shown).

Referring to FIGS. 6a-6d, the filter 12a, 12b, 12c is placed between the two adjacent pipe sections 14 (FIG. 3), with the seal members 24, 28 of each pipe section 14 pressed against the corresponding complementary seal members 30, 34 on the filter 12a, 12b, 12c. The engagement between the flat seal members 28, 34 are used to seal the edge portion of the filter inlet and outlet 32, while the engagement between the seal members 24, 30 seal the remainder of the perimeter of the filter inlet and outlet 32. The filter 12a, 12b, 12c and pipe section 14 include complementary components 36a, 36b of a suitable locking mechanism, which may be provided in the form of a latch, clamp, clip, or any other suitable locking mechanism, so as to releasably lock the filter 12a, 12b, 12c and pipe section 14 in engagement with each other with the seal members 24, 28 of the pipe section 14 in sealing engagement with the corresponding seal members 30, 34 of the filter 12a, 12b, 12c.

In the embodiment shown, and referring to FIGS. 6a and 6c, the locking mechanism 36a, 36b applies a clamping or compression force along a direction S which is transverse, and in a particular embodiment perpendicular, to the direction of flow F. The seal members 24, 28, 30, 34 are configured so that no portion of their engaging surfaces (i.e. surfaces of the seal members 24, 28, 30, 34 pressed against each other to define the sealed engagement) is parallel to the direction S of the clamping force. In a particular embodiment, this ensures that the full length of the seal members 24, 28, 30, 34 is compressed and provides an airtight seal when the filter 12a, 12b, 12c and pipe section 14 are latched together, sealing both the inlet and outlet of the filter 12a, 12b, 12c through the application of the compression force in the single direction S.

Referring particularly to FIG. 6a, it can be seen that the curved seal member 30 of the filter includes a curved portion 30a extending between two linear angled portions 30b, where the angled portions 30b extend at an angle θ with respect to the direction S of the clamping force, the angle θ having a value different than 0 since the angled portions 30b are nonparallel to the direction S of the clamping force. The curved seal member 24 of the pipe section 14 includes similar portions 24a, 24b. In the embodiment shown, the angle θ has a value of at least 30 degrees. Other values are also possible. Likewise, referring particularly to FIG. 6c, it can be seen that the seal member 30 of the filter includes a central portion 30a extending between two linear angled portions 30b, where the angled portions 30b extend at an angle θ with respect to the direction S of the clamping force, the angle θ having a value different than 0 since the angled portions 30b are nonparallel to the direction S of the clamping force. The straight-segment seal member 24 of the pipe section 14 includes similar portions 24a, 24b. In the embodiment shown, the angle θ has a value of at least 30 degrees. Other values are also possible.

In a particular embodiment, the angle θ is selected so that a sufficient amount of compression is reached in the angled portions 24b, 30b of the engaged seal members 24, 30. For example, in a particular embodiment, the seal members 24, 28 of the pipe sections 14 are defined by compressible gaskets, e.g. having a thickness of about ⅛ inch, and the seal members 30, 34 of the filter 12a, 12b, 12c are seal surfaces which upon engagement with the gaskets compress the gaskets to define the sealing engagement. The compression or clamping force is selected so that the gasket defining the flat seal member 28 on the pipe section 14 is compressed by the flat seal member 34 defined by the flat seal surface on the filter 12a, 12b, 12c by half of the thickness of the gasket. The compression along the angled portions 24b, 30b can be calculated as:

Cₘᵢₙ=C₀ sin θ

where Cₘᵢₙ is the minimum gasket compression along the angled portions 24b, 30b, C₀ is the nominal gasket compression along the flat seal members 28, 34, and θ>0°. In a particular embodiment, an angle θ of 30 degrees and a seal compression of 1/16 inch along the flat seal members 28, 34 provides for a minimum seal compression Cₘᵢₙ of at least 1/32 inch in the along the angled portions 24b, 30b.

It is understood that other values for the angle θ may be used. However, a larger angle θ generally increases the area sealed by the cooperating seal members 24, 28, 30, 34 and the seal length, thus requiring more sealing material. The angle must remain sufficiently large to ensure that the minimum seal compression is high enough for the sealing engagement to be effective.

In the embodiments shown, the sealed area defined by the cooperating seal members 24, 28, 30, 34 has a shape corresponding to a trapezoid (e.g., FIG. 3b) with a semi-circular top (e.g., FIG. 3a). In the embodiment with the trapezoid shape with semi-circular top, the sealed area can accordingly be calculated as:

$$A = {R}^{2} ( 2 + tan θ + \frac{π}{2} )$$

where A is the total area to be sealed on one surface (top or bottom) of the filter and R is half the depth D that the filter is inserted into the assembly 10, i.e. into the gap between the adjacent pipe sections 14. The area A is greater than or equal to the cross-sectional area of the opening 32, since the opening 32 is included in the area A. Accordingly, any exemplary values provided herein for the area A can be used to define a value for a maximum cross-sectional area for the opening 32 and/or the internal cross-sectional area of the pipe section 14. In the case of a trapezoid, the (b+B)D/2 formula can be used, with b being the length of the central segment 30a and B being the distance between the ends of the segments 30b.

In a particular embodiment, the filter 12a, 12b, 12c has dimensions of 15″ by 22″, and is inserted into the gap between the adjacent pipe sections at a depth D of approximately 4.5 inches, with the internal diameter of the pipe sections 14 being 4 inches. With an angle θ of 30 degrees as set forth above, the total area A to be sealed on one surface (top or bottom) of the filter is approximately 21 square inches, which corresponds to approximately 6.4% of the cross-sectional area of the filter (surface area of the top or bottom wall). In a particular embodiment, this combination defines an acceptable expected static pressure drop of 0.2 inH₂O in the transitions between the pipe sections 14 and the filter, based on computation fluid dynamics analysis. Accordingly, in a particular embodiment, the total area A to be sealed on one surface of the filter is at least 6.4% of the cross-sectional area of the filter. A smaller area A may however be used if a greater static pressure drop is acceptable in light of the capability of the vacuum system; in a particular embodiment, a smaller area A allows for a reduction in material costs.

It is understood that while the complementary seal member 24, 30 have been shown with a curved or trapezoid configuration, any other suitable shape may alternately be used, including, but not limited to, triangular, diamond, or any other complex shape allowing for the engaging surfaces of the seal members 24, 28, 30, 34 to be nonparallel to the direction S of the locking/clipping force providing the seal.

For example, in the embodiment of FIG. 3b, the cooperating seal members define a trapezoidal area with a depth corresponding to that of the filter, and a width corresponding to that of the filter. For example, for a filter having dimensions of 15″ by 22″, the trapezoidal area has a depth D of 15-inches and a width of 22 inches. Accordingly, for an angle θ of 30 degrees between the angled segments of the trapezoid and the direction S of the clamping force, the total area A to be sealed on one surface of the filter is 200 square inches, thus approximately 60.6% of the cross-sectional area of the filter. Accordingly, in a particular embodiment, the total area A to be sealed on one surface of the filter is at most 60.6% of the cross-sectional area of the filter. Higher values for the area A may be obtained for filters having different shapes and/or with a different angle, up to a value corresponding to that of the cross-sectional area of the filter (i.e., 100%).

In a particular embodiment, having the locking/clipping force providing the seal in the direction S perpendicular to the flow direction F allows to simplify the filter assembly 10 for example by allowing for the use of a simple opening 32 in the casing of the filter 12a, 12b, 12c to define each of the inlet and outlet 32, providing a sealing engagement directly on the wall of the casing where the opening 32 is defined without the need for additional ducting, and providing sealing directly with the outer surface of the pipe section 14. Moreover, this configuration allows for the seal to be defined along the junction between the filter 12a, 12b, 12c and the relatively small pipe section 14, as opposed to around the full perimeter of the filter 12a, 12b, 12c as is often the case in prior art assemblies. Accordingly, the seal length is dramatically reduced when compared to the conventional sealing around the full perimeter of the filter casing. In a particular embodiment, the length of the seal is approximately 70% smaller than a seal that would extend around the whole perimeter of the filter casing; other values are also possible. In a particular embodiment, a reduced seal length allows for a reduction in cost, an increase in material efficiency and/or reduction of the possibility of leakage.

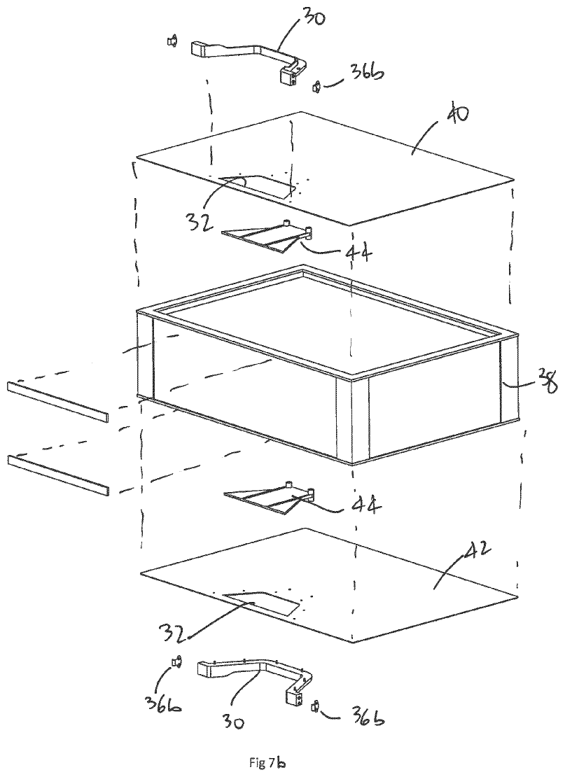

Referring to FIGS. 7a and 7b, one of the filter 12a, 12b, 12c in accordance with a particular embodiment is shown, which may be particularly, although not exclusively, suitable for filter medium that is or includes activated carbon. In a particular embodiment, the perimeter walls 38 are incorporated with the filter medium, which is provided in a cartridge format, and the top and bottom walls 40, 42 are configured as covers removably attached to the perimeter walls 38 to enclose the filter medium; other suitable configurations may alternately be used. Each of the inlet and outlet walls 40, 42 includes the respective seal member 30 protruding therefrom around the opening 32 defining the inlet/outlet. The openings 32 are defined adjacent the edge of the respective wall 40, 42 and the flat seal members 34 are provided on the perimeter wall 38 adjacent this edge. It can be seen that in this embodiment, a flow distribution plate 44 is provided inwardly of each of the inlet and outlet walls 40, 42, spaced apart therefrom and in alignment with the opening 32. The flow distribution plate 44 extends between the respective wall 40, 42 and the filter medium so as to help distribute the flow from the opening 32 throughout the complete cross-sectional area of the filter medium.

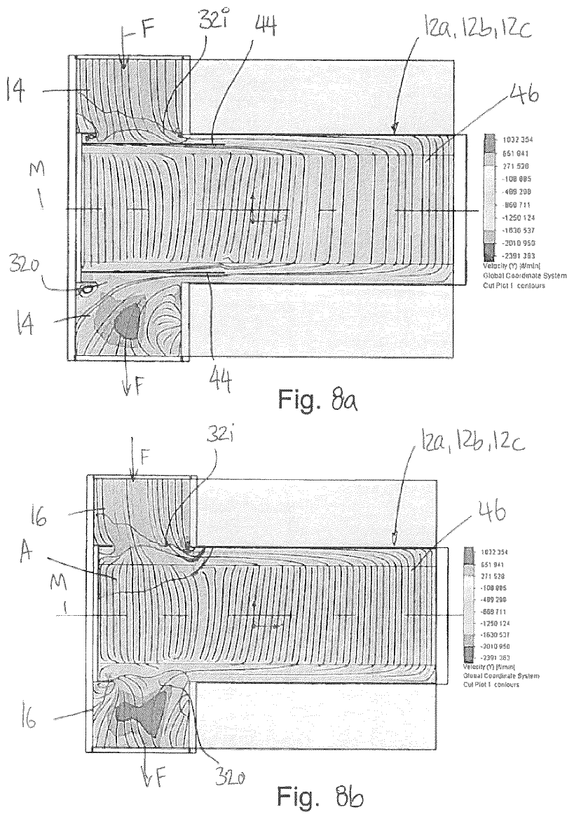

Referring to FIGS. 8a-8b, exemplary flow distributions are shown, for the filter 12a, 12b, 12c of FIG. 7a with the flow distribution plate 44 (FIG. 8a) and for a similar filter without the flow distribution plate 44 (FIG. 8b). In a particular embodiment and with reference to FIG. 8b, it was found through analysis with computation fluid dynamics that the sudden change in cross sectional area experienced by the flow F when transitioning in or out of the filter casing (i.e. from the relatively small inlet 32i to the casing enclosure and from the casing enclosure to the relatively small outlet 320) results in a large velocity difference through the filter 12a, 12b, 12c when the flow distribution plate 44 is omitted. For example, a region A of high velocity is present in the filter adjacent the inlet 32i, and accordingly the flow is more concentrated directly underneath the inlet 32i. A difference between the maximum and minimum flow velocity at the mid-plane M of the filter 12a, 12b, 12c can be for example of as much as 40%. This may be unfavorable as it may result in uneven utilization of the filter medium 46, which may lead to premature need for replacement.

By contrast, and with reference to FIG. 8a, the addition of the flow distribution plates 44 adjacent the inlet 32i and outlet 32o of the filter 12a, 12b, 12c allows to better distribute the flow F. It can be seen that with the flow distributor plates 44, the region of high velocity in the filter adjacent the inlet 32i has disappeared. In a particular embodiment, the presence of the flow distribution plates 44 reduces the difference between the maximum and minimum flow velocity at the mid-plane M of the filter 12a, 12b, 12c to about 7%. The flow distribution plates 44 thus allow for a significant improvement in flow distribution, which may allow the filter medium 46 to be more evenly used through its life, and accordingly result in longer life for the filter 12a, 12b, 12c. In a particular embodiment, the pressure drop associated with the flow distribution plates 44 is negligible, for example about 0.3 inH₂O at a flow rate of 200 CFM. In a particular embodiment, the flow distribution plates 44 accordingly allow to evenly distribute the gaseous contaminant laden air across the face of the filter medium to minimize preferential loading of the filter and/or to equalize air velocity across the cross section of the filter.

The specific shape and size of the flow distribution plates 44 may be determined based on flow equalization performance as well as static pressure loss requirement. In the embodiment shown, each flow distribution plate 44 has a surface area equal or approximately equal to the cross-sectional area of the corresponding opening 32 in the filter casing, and has a rectangular shape, for example corresponding to (e.g. proportional to) that of the perimeter of the casing of the filter 12a, 12b, 12c, while the opening 32 is non-rectangular, e.g. has a circular shape or has the shape of a truncated circle (as shown). Other configurations may alternately be used.

It is understood that for filter media where flow distribution is not important, the flow distribution plate 44 may be omitted. Alternately, a single flow distribution plate 44 may be provided, depending on the requirement of flow distribution. The flow distribution plate 44 may also be used to improve the flow distribution in filters forming part of different types of filter assemblies.

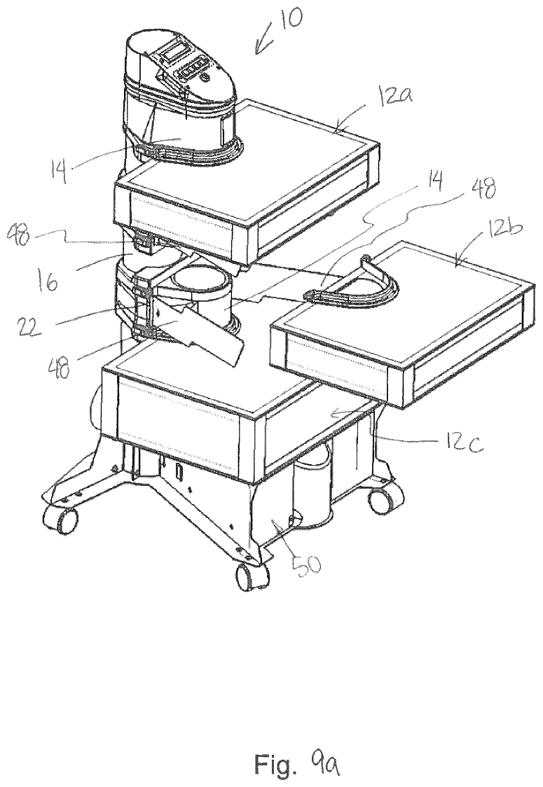

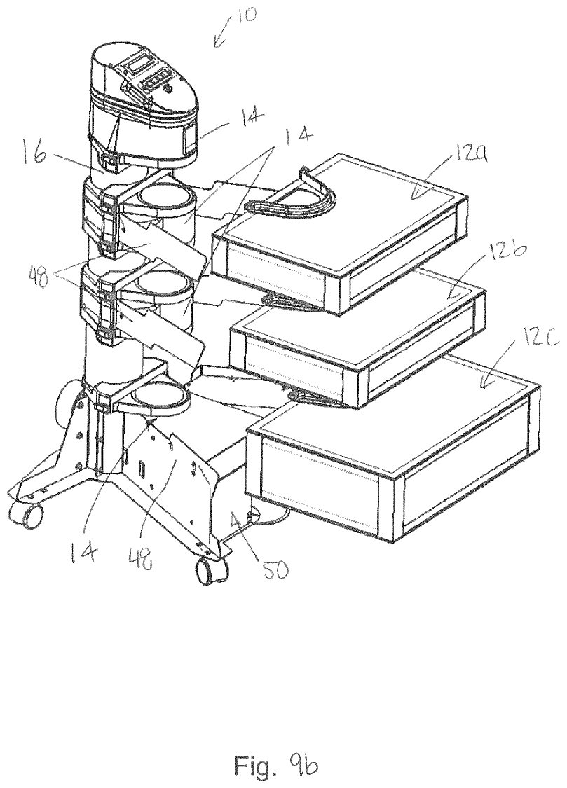

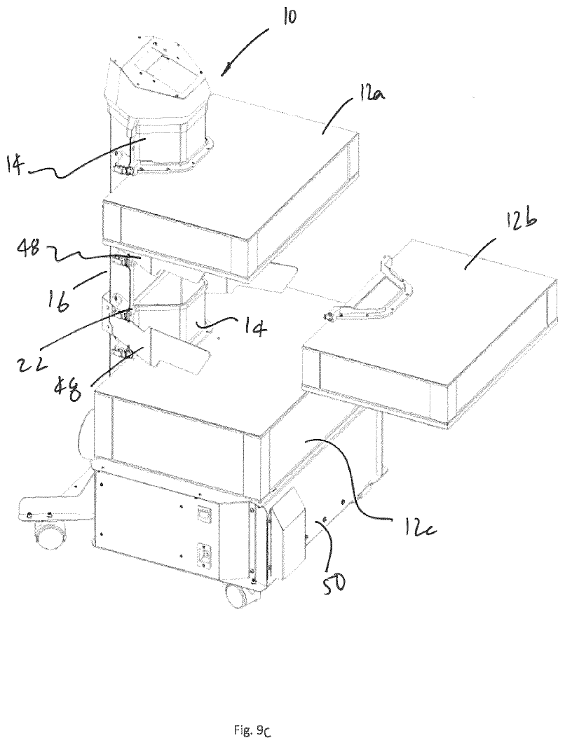

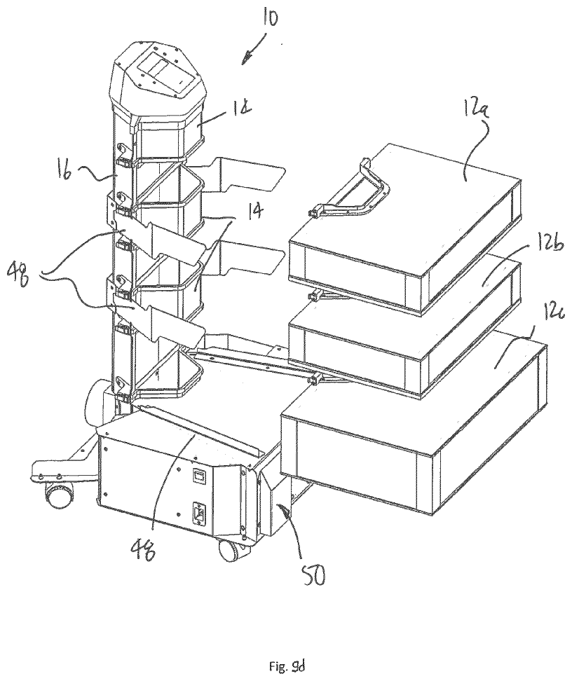

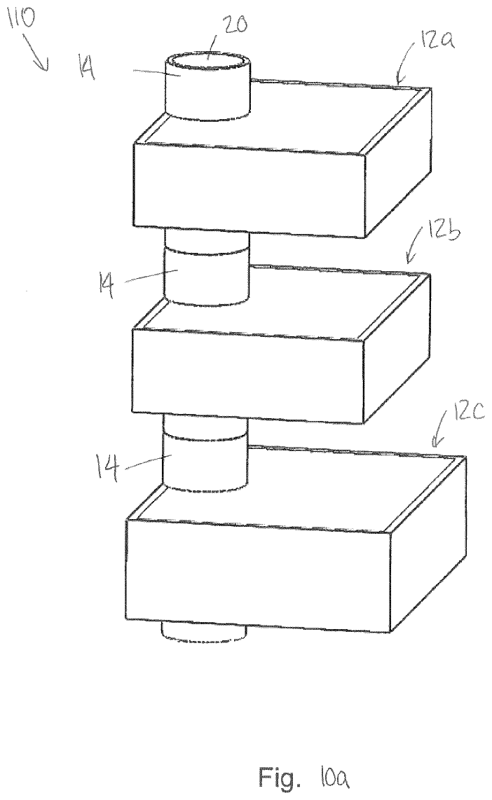

Referring to FIGS. 9a-9d, the seal assembly between the pipe sections 14 and the filters 12a, 12b, 12c allows for the filters 12a, 12b, 12c to be independently replaceable, since the locking mechanisms 36a, 36b engage each of the filters 12a, 12b, 12c to the corresponding pipe sections 14 independently of the other filters 12a, 12b, 12c. Each filter 12a, 12b, 12c can be removed without the need to manipulate any of the other filters 12a, 12b, 12c. In the embodiment shown, the supports 22 of the pipe sections 14 extending under the two highest filters 12a, 12b each include a pair support arms 48 protruding from the respective pipe section 14, and the respective filter 12a, 12b is received over and supported by the support arms 48 when locked in engagement with the pipe section 14, with the bottom wall resting on the support arms 48. The filter assembly further includes a base 50 in which the lowest pipe section 14 is defined, and the sides of the base 50 also define support arms 48 similarly supporting the lowermost filter 12c when locked in engagement with the pipe section 14 defined in the base 50. The support arms 48 thus support the filters 12a, 12b, 12c in a vertically spaced apart configuration and allow the filters 12a, 12b, 12c to individually slide in and out of their engagement with the corresponding pipe sections 14. In the embodiment shown, the base 50 is supported on suitable wheels so that the filter assembly 10 is displaceable; it is understood that any other suitable configuration may alternately be used.

It is understood that the support arms 48 may alternately be replaced by any other type of suitable support structure, including, but not limited to, a support platform extending underneath each of the filters 12a, 12b, 12c.

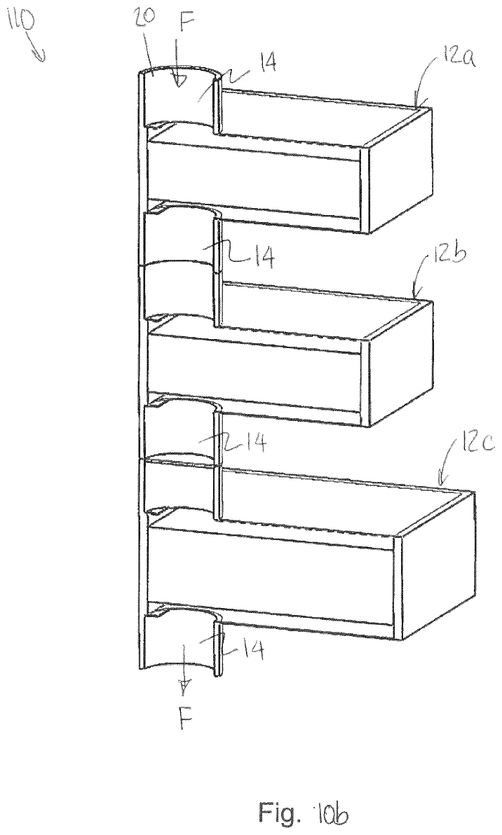

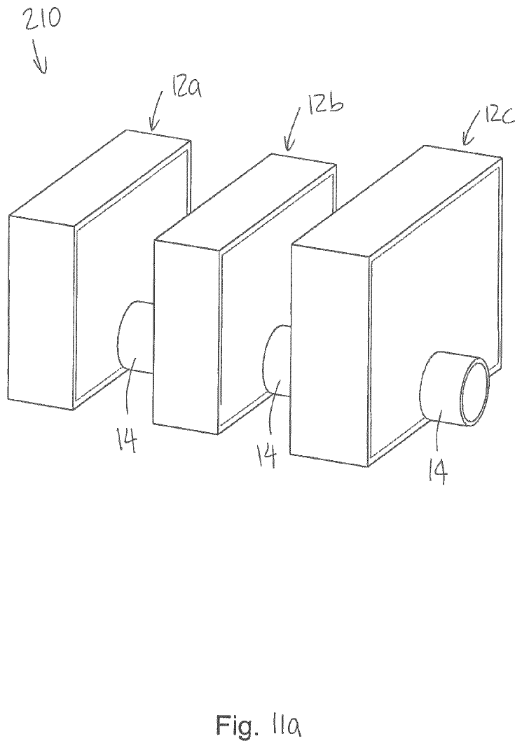

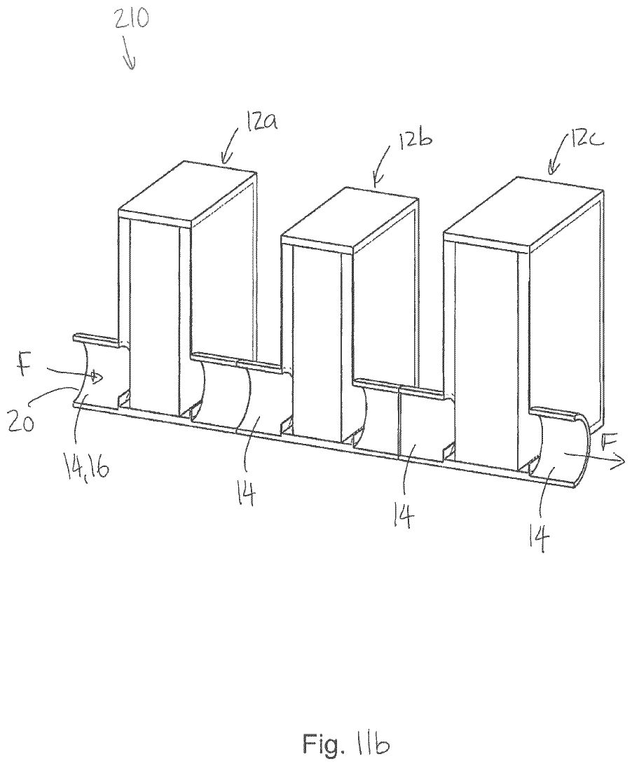

It is understood that the configuration shown for the filter assembly 10, including but not limited to the relative position of the filters 12a, 12b, 12c and of the inlet duct 16, is exemplary only and that any other suitable configuration may alternately be used. For example and with reference to FIGS. 10a-10b, in the case of a central extraction system and/or configurations where the filter assembly 110 is fixed to a static wall, or in any other appropriate situation, the inlet 20 may be placed at the top without the need for a U-shaped inlet duct 16 as described above; the inlet 20 is accordingly directly defined by the pipe section 14 connected to the inlet of the upstream-most filter 12a. As another example and with reference to FIGS. 11a-11b, the filter assembly 110 may be oriented horizontally, so that the filters 12a, 12b, 12c are horizontally spaced apart from each other, with the inlet 20 also directly defined by the pipe section 14 connected to the inlet of the upstream-most filter 12a. In both filter assemblies 110, 210, the sealing engagement between the filters 12a, 12b, 12c and adjacent pipe sections 14 may be defined as set forth above for the filter assembly 10, for example as shown in FIGS. 4-7. Other configurations are also possible.

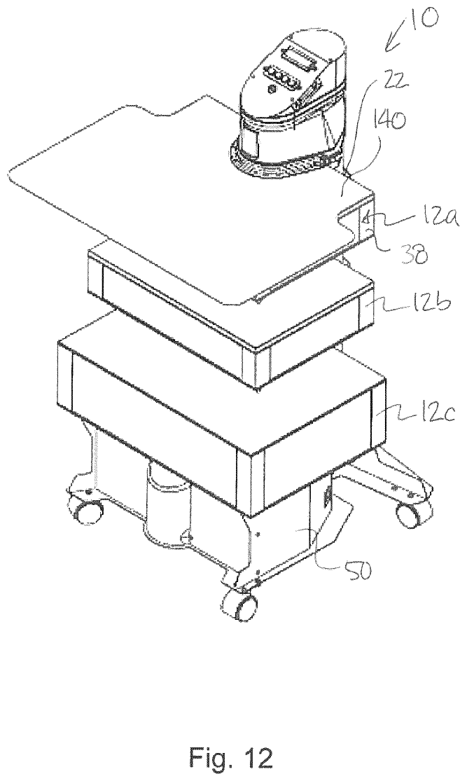

FIG. 12 illustrates an optional feature of the filter assembly 10. In this embodiment, the top wall 140 of the topmost filter 12a is enlarged so have a cross-sectional area greater than the cross-sectional area defined by the perimeter wall 38; for example, in the embodiment shown, the top wall 14 extends beyond the perimeter wall 38 along the three faces not abutting the support 22. The enlarged top wall 140 defines a platform usable as a workstation. In some embodiments, the filter assembly 10 is used to extract fumes from machining equipment such as a laser engraving/cutting/marking machine. The filter assembly 10 is typically placed in close proximity to the machining equipment so as to have a low static pressure loss within the connecting hose between the machining equipment and the filter assembly inlet. The operator of the machining equipment typically uses control equipment, such as a laptop computer, to control the machining equipment, e.g. send graphic files and drive the laser. The enlarged top wall 140 is thus usable as a workstation to receive the control equipment in proximity of the machining equipment, eliminating the need for a separate workstation.

In a particular embodiment, the filter assembly 10, 110, 210 provides the benefits of individual replacement provided by single unit enclosure type-assemblies without the need for a single unit enclosure, and accordingly without the increased material, labor and/or significant tooling required to create the single unit enclosure.

The above description is meant to be exemplary only, and one skilled in the art will recognize that changes may be made to the embodiments described without departing from the scope of the invention disclosed. For example, there may be applications where only a series of particulate filters are used (without a gas filter), though the filters will be of different efficiencies or different media to address different type of particulates that may exist in the particulate contaminant mixture which may be free of gaseous contaminants. There also may be applications where only a series of gas filters are used (no particulate filters), though the filters will be of different efficiencies or different media to address different type of gases that may exist in the gaseous contaminant mixture which may be free of particulate contaminant. Modifications which fall within the scope of the present invention will be apparent to those skilled in the art, in light of a review of this disclosure, and such modifications are intended to fall within the appended claims.

1. A filter assembly for a fume extraction system, the assembly comprising:
a plurality of filters spaced apart from one another;
a plurality of pipe sections serially interconnecting the filters such that each of the filters extends between first and second corresponding ones of the pipe sections, each of the filters having a first wall and a second wall opposite the first wall, the first and second walls each having a respective opening defined therethrough, the opening of the first wall fluidly connected to the first corresponding one of the pipe sections, the opening of the second wall fluidly connected to the second corresponding one of the pipe sections; and
for each of the filters, first and second respective locking mechanisms releasably engaging the filter to the first and second corresponding ones of the pipe sections such that each of the filters is independently removable from the filter assembly through release of the first and second respective locking mechanisms.

2. The filter assembly as defined in claim 1, wherein the first and second locking mechanisms provide a clamping force along a direction transverse to a direction of flow within the pipe sections.

3. The filter assembly as defined in claim 2, further comprising, for each of the filters:
a first respective seal assembly defining a sealed engagement between the opening of the first wall and the first corresponding one of the pipe sections, the first respective seal assembly including a first seal member extending from the first wall around the opening defined therethrough, and a second seal member provided on the first corresponding one of the pipe sections and sealingly engaged to the first seal member, the first and second seal members being configured so that engaging surfaces thereof extend non-parallel to the direction of the clamping force; and
a second respective seal assembly defining a sealed engagement between the opening of the second wall and the second corresponding one of the pipe sections, the second respective seal assembly including a third seal member extending from the second wall around the opening defined therethrough, and a fourth seal member provided on the second corresponding one of the pipe sections and sealingly engaged to the third seal member, the third and fourth seal members being configured so that engaging surfaces thereof extend non-parallel to the direction of the clamping force.

4. The filter assembly as defined in claim 3, wherein the first, second, third and fourth seal members define a curved segment and/or sequence of generally straight segments.

5. The filter assembly as defined in claim 3, wherein:
the first respective seal assembly further includes a first additional seal member on a perimeter wall of the filter adjacent the opening of the first wall and in abutment with a support of the pipe sections, and a second additional seal member on the support and sealingly engaged to the first additional seal member, the first and second additional seal members being configured so that engaging surfaces thereof extend non-parallel to the direction of the clamping force; and
the second respective seal assembly further includes a third additional seal member on the perimeter wall of the filter adjacent the opening of the third wall, and a fourth additional seal member on the support and sealingly engaged to the third additional seal member, the third and fourth additional seal members being configured so that engaging surfaces thereof extend non-parallel to the direction of the clamping force.

6. The filter assembly as defined in claim 1, wherein the filters are vertically spaced apart.

7. The filter assembly as defined in claim 6, wherein the first wall is a top wall and the second wall is a bottom wall, the assembly further comprising a pair of support arms extending from the second corresponding one of the pipe sections, the bottom wall resting on the support arms.

8. The filter assembly as defined in claim 6, wherein an upstream-most of the filters is located on top of remaining ones of the filters, the assembly further comprising an inlet duct having an inlet defined at a lower end thereof adjacent a lowest of the filters, the inlet duct extending upwardly from the inlet adjacent the filters and having a U-shaped portion adjacent a connection between the inlet duct and the upstream-most of the filters.

9. The filter assembly as defined in claim 6, wherein a topmost of the filters has an enlarged top wall having a cross-sectional area greater than that defined by a perimeter wall of the topmost filter, the enlarged top wall usable as a workstation.

10. The filter assembly as defined in claim 1, wherein the filters include at least one particulate filter and at least one gaseous filter.

11. The filter assembly as defined in claim 1, wherein the filters are horizontally spaced apart.

12. The filter assembly as defined in claim 1, wherein each of the pipe sections has a cross-sectional area smaller than a cross-sectional area of any one of the filters.

13. A filter assembly for a fume extraction system, the assembly comprising:
a plurality of filters spaced apart from one another; and
a plurality of pipe sections serially interconnecting the filters, each of the filters having two opposed walls interconnected by a perimeter wall defining a closed perimeter, each of the opposed walls having an opening defined therethrough, the opening of a first one of the opposed walls defining an inlet and the opening of a second one of the opposed walls defining an outlet, each opening fluidly connected to a respective one of the pipe sections via a respective seal assembly;
wherein each respective seal assembly includes:
a locking mechanism engaging the filter to the respective pipe section, the locking mechanism providing a compression force along a direction transverse to a direction of flow within the pipe sections;
at least one seal member on the filter around the opening;
at least one seal member on the respective pipe section and sealingly engaged to the at least one seal member on the filter, the seal members on the filter and respective pipe section being configured so that engaging surfaces thereof extend non-parallel to the direction of the clamping force.

14. A filter comprising:
a perimeter wall defining a closed perimeter surrounding filter medium, and first and second walls interconnected by the perimeter wall to enclose the filter medium, the first wall having an opening therethrough defining an inlet, the second wall having an opening therethrough defining an outlet;
a flow distribution plate provided between the first wall and the filter medium and spaced apart from the first wall, the flow distribution plate aligned with the opening defined through the first wall.

15. The filter as defined in claim 14, further comprising a second flow distribution plate provided between the second wall and the filter medium and spaced apart from the second wall, the flow distribution plate aligned with the opening defined through the second wall.

16. The filter as defined in claim 14, wherein a surface area of the flow distribution plate is approximately equal to a cross-sectional area of the opening through the first wall.

17. The filter as defined in claim 14, wherein the closed perimeter is rectangular, the opening through the first wall is non-rectangular, and the flow distribution plate is rectangular.

18. The filter as defined in claim 14, wherein the opening in the first wall occupies at least 4% of a surface area of the first wall.

19. The filter as defined in claim 14, wherein the filter medium includes activated carbon.
